(19) United States
(12) Patent Application Publication
(10) Pub. No.: US 2005/0081086 A1
(43) Pub. Date: Apr. 14, 2005

(54) Method, apparatus and program storage device for optimizing storage device distribution within a RAID to provide fault tolerance for the RAID

(75) Inventor: Jeffrey Lane Williams, Rochester, MN (US)

Correspondence Address: Crawford Maunu PLLC, Suite 390, 1270 Northland Drive, St. Paul, MN, 55120, US

(73) Assignee: XIOtech Corporation

(21) Appl. No.: 10/683,541

(22) Filed: Oct. 10, 2003

(51) Int. Cl. G06F 11/00

(52) U.S. Cl. 714/5

(57) ABSTRACT

A method, apparatus and program storage device for optimizing storage device distribution within a RAID to provide fault tolerance for the RAID is disclosed. A distribution of storage devices is determined and the distribution of storage devices is analyzed to provide a distribution that optimizes the fault tolerance of the RAID.

### BACKGROUND OF THE INVENTION

1. Field of the Invention

This invention relates in general to storage device array systems, and more particularly to a method, apparatus and program storage device for optimizing storage device distribution within a RAID to provide fault tolerance for the RAID.

2. Description of Related Art

Arrayed storage systems provide both improved capacity and performance as compared to single storage devices. In an arrayed storage system, a plurality of storage devices are used in a cooperative manner such that multiple storage devices are performing, in parallel, the tasks normally performed by a single storage device. Striping techniques are often used to spread large amounts of information over a plurality of storage devices in an arrayed storage system. So spreading the data over multiple storage devices improves perceived performance of the storage system in that a large I/O operation is processed by multiple storage devices in parallel rather than being queued awaiting processing by a single storage device.

However, adding multiple storage devices to a storage system reduces to reliability of the overall storage system. In particular, spreading data over multiple storage devices in a storage device array increases the potential for system failure. Failure of any of the multiple storage devices translates to failure of the storage system because the data stored thereon cannot be correctly retrieved. Modem computers require a large, fault-tolerant data storage system.

RAID techniques are commonly used to improve reliability in arrayed storage systems. RAID techniques generally configure multiple storage devices in a storage array in geometries that permit redundancy of stored data to assure data integrity in case of various failures. In many such redundant subsystems, recovery from many common failures can be automated within the storage subsystem itself due to the use of data redundancy, error codes, and so-called “hot spares” (extra storage devices that may be activated to replace a failed, previously active storage device). The 1987 publication by David A. Patterson, et al., from University of California at Berkeley entitled A Case for Redundant Arrays of Inexpensive Disks (RAID), reviews the fundamental concepts of RAID technology.

RAID level zero, also commonly referred to as striping, distributes data as stored on a storage subsystem across a plurality of storage devices to permit parallel operation of a plurality of storage devices thereby improving the performance of I/O write requests to the storage subsystem. Though RAID level zero functionality improves I/O write operation performance, reliability of the storage array subsystem is decreased as compared to that of a single large storage device. To improve reliability of storage arrays, other RAID geometries for data storage include generation and storage of redundancy information to permit continued operation of the storage array through certain common failure modes of the storage devices in the storage array.

There are additional “levels” of standard RAID geometries that include redundancy information as defined in the Patterson publication. Other RAID geometries have been more recently adopted and utilize similar concepts. For example, RAID level six provides additional redundancy to enable continued operation even in the case of failure of two storage devices in a storage array.

The simplest array, a RAID level 1 system, comprises one or more storage devices for storing data and an equal number of additional “mirror” devices for storing copies of the information written to the data storage devices. The remaining RAID levels, identified as RAID levels 2, 3, 4 and 5 systems by Patterson, segment the data into portions for storage across several data storage devices. One or more additional storage devices are utilized to store error check or parity information. RAID level 6 further enhances reliability by adding additional redundancy information to permit continued operation through multiple storage device failures. The methods of the present invention may be useful in conjunction with any of the standard RAID levels.

A conventional array controller consists of several individual storage device controllers combined with a rack of storage devices to provide a fault-tolerant data storage system that is directly attached to a host computer. The host computer is then connected to a network of client computers to provide a large, fault-tolerant pool of storage accessible to all network clients. Typically, the array controller provides the brains of the data storage system, servicing all host requests, storing data to multiple (RAID) storage devices, caching data for fast access, and handling storage device failures without interrupting host requests.

The controller makes the subsystem appear to the host computer as one (or more), highly reliable, high capacity storage device. In fact, the RAID controller may distribute the host computer system supplied data across a plurality of the small independent storage devices with redundancy and error checking information so as to improve subsystem reliability. The mapping of a logical location of the host supplied data to a physical location on the array of storage devices is performed by the controller in a manner that is transparent to the host system. RAID level 0 striping for example is transparent to the host system. The data is simply distributed by the controller over a plurality of storage devices in the array to improve overall system performance.

RAID storage systems generally subdivide the arrayed storage capacity into distinct partitions referred to as logical units (LUNs). Each logical unit may be managed in accordance with a selected RAID management technique. In other words, each LUN may use a different RAID management level as required for its particular application.

A typical sequence in configuring LUNs in a RAID system involves a user (typically a system administrator) defining storage space to create a particular LUN. With the storage space so defined, a preferred RAID storage management technique is associated with the newly created LUN. The storage space of the LUN is then typically initialized—a process that involves formatting the storage space associated with the LUN to clear any previously stored data and involves initializing any redundancy information required by the associated RAID management level.

Thus, arrayed systems, such as RAIDs, are used to reliably store data by essentially spreading the data over plural storage devices operating in concert. However, typically, the redundancy of the array can recover form failure of only one storage device. As mentioned above, if a single storage device fails, the redundancy built into the array is able to recreate the data. Nevertheless, if an entire enclosure of storage devices fails, the array system may not be able to recover.

Also, in RAID systems, multiple controllers may be each connected to the same group of storage devices for redundancy. In a typical configuration, each controller is coupled to a number of hubs. Each of the hubs may be connected to a plurality of storage device enclosures. Each enclosure can include several storage devices. Because of the significant amount of cabling involved, there is the possibility for cabling errors or failures in connecting the storage devices. In such an arrangement, if an enclosure becomes unavailable, the array system cannot recover.

It can be seen that there is a need for a method, apparatus and program storage device for optimizing storage device distribution within a RAID to provide fault tolerance for the RAID.

### SUMMARY OF THE INVENTION

To overcome the limitations in the prior art described above, and to overcome other limitations that will become apparent upon reading and understanding the present specification, the present invention discloses a method, apparatus and program storage device for optimizing storage device distribution within a RAID to provide fault tolerance for the RAID.

The present invention solves the above-described problems by determining a distribution of storage devices and analyzing the distribution of storage devices to provide a distribution of the storage devices that optimizes the fault tolerance of the RAID.

A method in accordance with the principles of an embodiment of the present invention includes determining an enclosure associated with each of a plurality of storage devices, performing a fault tolerance analysis on the storage devices and selecting a distribution order for the storage devices within a RAID system based on the fault tolerance analysis to provide maximum fault tolerance for the RAID system.

In another embodiment of the present invention, a RAID controller is provided. The RAID controller includes a memory for storing data and a processor, coupled to the memory, the processor being configured for determining an enclosure associated with each of a plurality of storage devices, performing a fault tolerance analysis on the storage devices and selecting a distribution order for the storage devices within a RAID system based on the fault tolerance analysis to provide maximum fault tolerance for the RAID system.

In another embodiment of the present invention, a RAID storage system is provided. The RAID storage system includes a plurality of storage devices disposed within storage device enclosures and a RAID controller, coupled to the plurality of storage devices, the RAID controller determining an enclosure associated with each of a plurality of storage devices, performing a fault tolerance analysis on the storage devices and selecting a distribution order for the storage devices within a RAID system based on the fault tolerance analysis to provide maximum fault tolerance for the RAID system.

In another embodiment of the present invention, a program storage device readable by a computer and tangibly embodying one or more programs of instructions executable by the computer to perform a method for optimizing storage device distribution within a RAID is disclosed. The method includes determining an enclosure associated with each of a plurality of storage devices, performing a fault tolerance analysis on the storage devices and selecting a distribution order for the storage devices within a RAID system based on the fault tolerance analysis to provide maximum fault tolerance for the RAID system.

In another embodiment of the present invention, another RAID controller is provided. This RAID controller includes means for storing data and means, coupled to the means for storing data, for processing instruction to determine an enclosure associated with each of a plurality of storage devices, to perform a fault tolerance analysis on the storage devices and to select a distribution order for the storage devices within a RAID system based on the fault tolerance analysis to provide maximum fault tolerance for the RAID system.

In another embodiment of the present invention, another RAID storage system is provided. This RAID storage system includes means for providing storage space, the means for providing storage space being enclosed within means for grouping the means for providing storage space and means, coupled to the means for providing storage space, for determining an enclosure associated with each of a plurality of storage devices, performing a fault tolerance analysis on the storage devices and selecting a distribution order for the storage devices within a RAID system based on the fault tolerance analysis to provide maximum fault tolerance for the RAID system.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a storage system according to an embodiment of the present invention;

FIG. 2 illustrates a RAID system according to an embodiment of the present invention; and

FIG. 3 is a flow chart of the method for optimizing storage device distribution within a RAID to provide fault tolerance for the RAID according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for optimizing storage device distribution within a RAID to provide fault tolerance for the RAID. An optimal storage device ordering within the RAID provides increased reliability and allows the system to remain useable even though storage devices may fail. The use of information such as which physical enclosure a storage device resides in should be used to optimize storage device ordering.

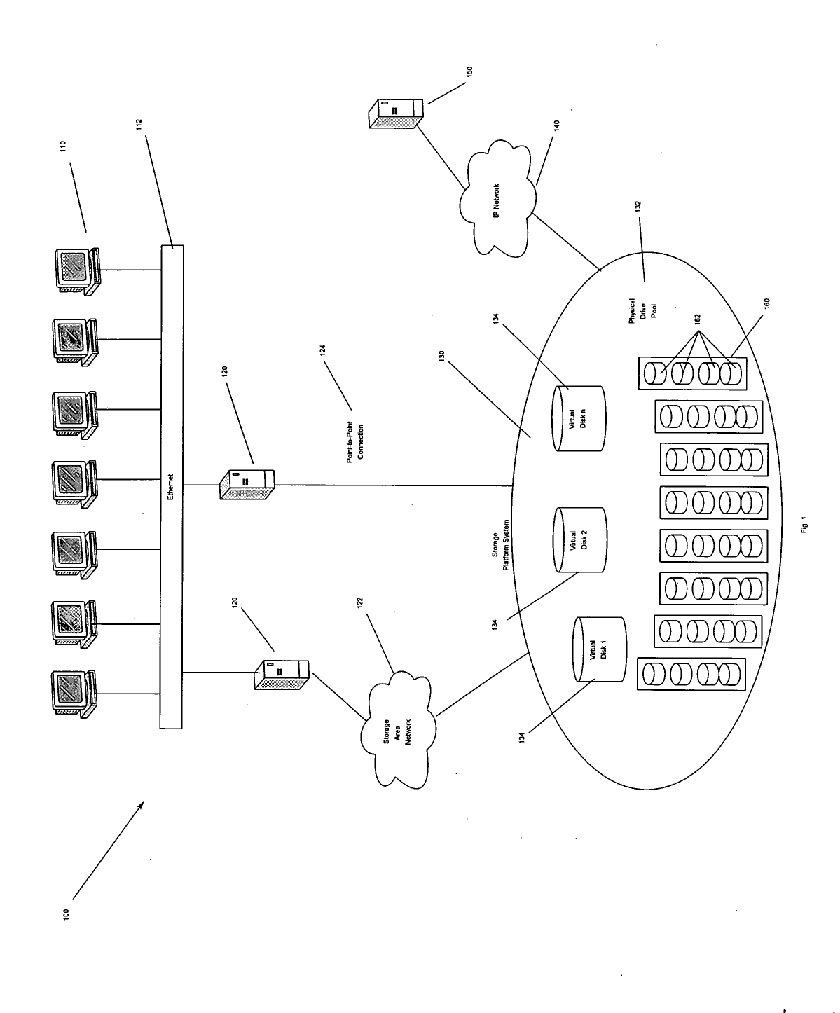

FIG. 1 illustrates a storage system 100 according to an embodiment of the present invention. In FIG. 1, multiple users 110 are coupled to a network 112. For example, Ethernet is one type of network 112. Ethernet is generally placed at the data link layer of the Open System Interconnect (OSI) 7-layer model, second from the bottom, but it also includes elements of the physical layer.

An access node 120 is coupled to a storage platform system 130. The access node 120 may be a server that is accessed by the users via Ethernet, for example, as discussed above, a gateway device, etc. The access node 120 may be coupled to the storage platform system 130 via a storage area network 122, a point-to-point connection 124, etc.

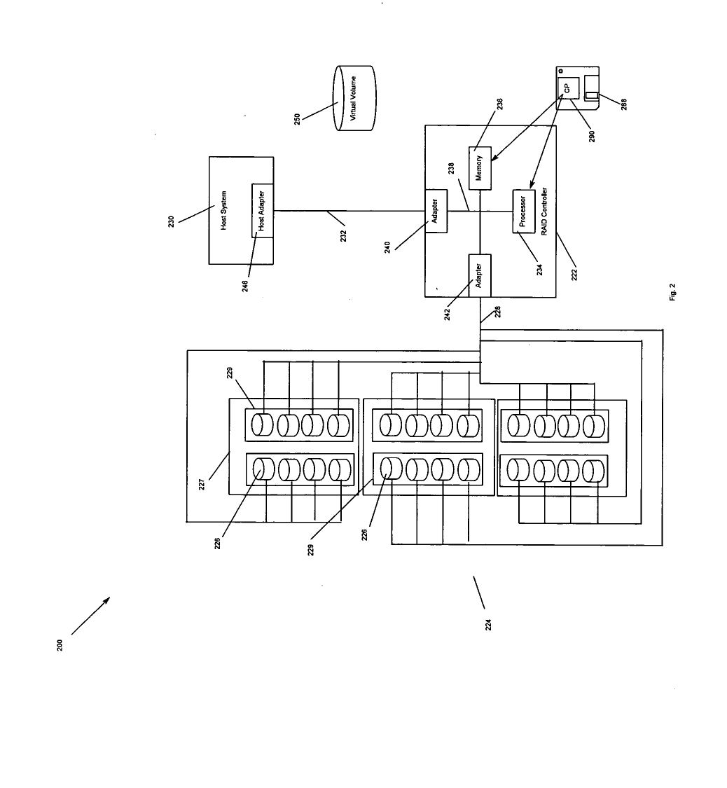

To the user 110, the storage platform system 130 appears as virtual storage device 134. The virtual storage device 134 may include a pool of storage devices 132 that are managed by a RAID controller as shown in FIG. 2. The pool of storage devices may include a plurality of enclosures 160, wherein each enclosure includes a plurality of storage devices 162. One function of the RAID controllers is to represent information on the pool of storage devices 132 to the user as at least one virtual device 134, such as virtual device volume.

The management module is connected to the pool of storage devices 132 to control the allocation of data on the physical storage devices 162. The information on the pool of storage devices 132 is presented to the computer systems of the users 110 as one or more virtual storage devices 134 and information in the virtual storage devices 134 is mapped to the pool of storage devices 132. The storage platform system 130 may be expanded via a network connection 140, e.g., IP Network, to a remote storage platform system 150.

FIG. 2 illustrates a RAID system 200 according to an embodiment of the present invention. In FIG. 2, the RAID system 200 includes a RAID controller 222 and an array 224 of independent storage devices 226. The storage devices 226 are separated into groups 227 of storage devices 226, wherein each group 227 may represent a plurality of enclosures 229, and each enclosure 229 may include several storage devices 226 that are accessible by link 228.

The RAID controller 222 operates in accordance with the present invention to selectively map data to the storage devices 226 in a manner that optimizes storage device distribution within a RAID to provide fault tolerance for the RAID. Each of the enclosures 229 is coupled to the RAID controller 222. The RAID controller 222 is also coupled to a host computer 230, which facilitates user control of the RAID controller 222. The host computer 230 is connected to the RAID controller 222 by way of a link 232.

The RAID controller comprises a microprocessor 234 and memory 236. The memory and the microprocessor are connected by a controller bus 238 and operate to control the mapping algorithms for the array 224. The RAID controller 222 communicates with the host computer system through an adapter 240, which is connected to link 232. The RAID controller 222 similarly communicates with the array 224 through adapter 242, which is coupled to link 228 and to the enclosures 227. For example, the adapters 240 and 242 maybe Small Computer System Interface (SCSI) adapters.

The array 224 shown in FIG. 2 is a collection of storage devices 226 which are relatively independent storage elements, capable of controlling their own operation and responding to input/output (I/O) commands autonomously, which is a relatively common capability of modem storage devices. The particular storage devices 226 may be either magnetic or optical disks and are capable of data conversion, device control, error recovery, and bus arbitration; i.e., they are intelligent storage elements similar to those commonly found in personal computers, workstations and small servers.

Although the storage devices 226 may be specially adapted for use in arrays 224, e.g., requiring that the storage devices 226 be synchronized, general-purpose storage devices, which are more commonly used for striped and mirrored arrays, may also be used. Data is transferred to and from the array 224 via link 228. Link 228 essentially moves commands, storage device responses and data between the I/O bus adapter 242 and the array 224. In an embodiment, the link 228 represents one or more channels comprising one or more SCSI buses. Alternatively, link 228 may be a collection of channels that use some other technology, e.g., an IDE based bus system, a wireless LAN, etc.

The host computer 230 provides host software access to the RAID controller 222 so that commands can be executed in accordance with predetermined RAID algorithms. The host computer 230 executes applications, such as online database or transaction applications. The host 230 uses I/O driver software to communicate application requests to the link 232 through the host adapter 246. Moreover the host 230 contains the main memory (not shown) that is the destination for data read from storage devices 226 and the source for data written to the storage devices 226.

The adapter 246 provides an interface between the memory on the host 230 and the link 232. The host adapter 246 accepts commands from the I/O driver, translates them as necessary, and relays them to the RAID controller 222 using the link 232. Further, the host adapter 246 receives information from the RAID controller 222 and forwards that information on to host 230 for host processing. Similarly, adapters 240 and 242 located in the RAID controller 222 perform many of the same functions as the adapter 246 in terms of communicating commands and data between links 232 and 228 and the memory 236 respectively in the RAID controller 222. In alternative embodiments, the RAID controller 222 shown in FIG. 2 may be incorporated into the host computer system 230. However, the RAID controller 222 is shown separately here and represents an intelligent controller, which is interposed between the host adapter 246 and the storage devices 226. In this configuration, the intelligent controller facilitates the connection of larger numbers of storage devices 226 and other storage devices to the host computers 230. Moreover, intelligent controllers such as RAID controller 222 typically provide communication with a higher capacity I/O link 228 than normally available with non-intelligent controllers. Therefore, I/O system data transfer capacity is generally much larger with an intermediate intelligent controller such as the RAID controller 222 shown in FIG. 2.

The array 224 comprises storage devices 226 that are managed by the RAID controller 222. The RAID controller 222 comprises software executing on the RAID controller 222. One function of the RAID controller 222 is to represent information on the storage devices 226 to the host computer 230 as at least one virtual storage device 250. The virtual storage device 250 is also referred to herein as a logical unit, wherein the logical unit may be identified by a logical unit number (LUN). During its creation, the space available for the LUN 250 is logically divided into a number segments or strips by the RAID controller 222. These strips are then mapped to the various storage devices 226 according to the method for optimizing storage device distribution within a RAID to provide fault tolerance for the RAID according to an embodiment of the present invention.

In FIG. 2, a single RAID controller 222 is shown coupled to the host 230. However, those skilled in the art will recognize that the present invention is not meant to be limited to this configuration. Rather, the system according to an embodiment of the present invention may include several RAID controllers 222. Further, multiple RAID controllers 222 may be each connected to a hub 227 of storage devices 226.

In a typical configuration, each controller is coupled to a number of hubs 227. Each of the hubs 227 may include several storage device enclosures 229. Each enclosure 229 can include several storage devices 226. Because of the significant amount of cabling involved, there is the possibility for cabling errors or failures in connecting the storage devices 226.

The RAID controller 222 is an intelligent manager that manages the array 224 of storage devices 226 in such a way that data is protected in the event of a failure of a storage device 226. The RAID controller 222 stripes data across an array of storage devices 226 so that the array appears as one logical storage device unit 250. The RAID controller 222 generates redundancy information and stores it on the array so that data can be regenerated upon failure of a storage device 226.

According to an embodiment of the present invention, the RAID controller 222 provides optimal storage device ordering within the RAID to increase reliability and allow the system to remain useable even though storage devices 226 may fail. The RAID controller 222 uses information, such as which physical enclosure 229 a storage device 226 resides in, to optimize ordering of the storage devices 226 in a RAID. The distribution obtained by the RAID controller 222 allows a RAID to be sustained even though an entire enclosure 229 of storage devices 226 fails.

The RAID controller 222 gathers information from the enclosure 229 to determine a location for each storage device 226. The enclosure 229 associated with each of a plurality of storage devices 226 is determined. Then, the RAID controller 222 performs a fault tolerance analysis on the storage devices 226 based upon a distribution of the storage devices 226. The RAID controller 222 selects a distribution order for the storage devices 226 within a RAID system based on the fault tolerance analysis to provide maximum fault tolerance for the RAID. In performing the fault tolerance analysis, the RAID controller 222 may consider different types and orders of failure affecting all storage devices in an enclosure. The RAID controller 222 may also consider failures of the link 228 to the storage devices 226.

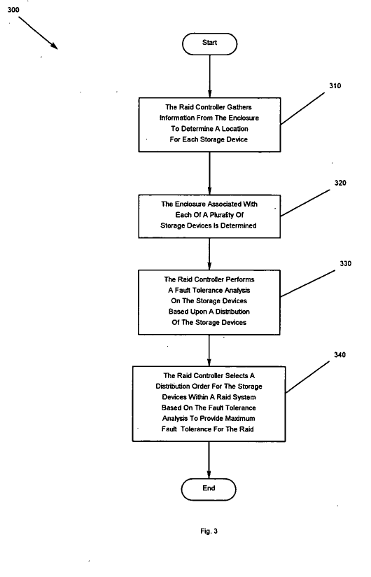

FIG. 3 is a flow chart 300 of the method for optimizing storage device distribution within a RAID to provide fault tolerance for the RAID according to an embodiment of the present invention. The RAID controller gathers information from the enclosure to determine a location for each storage device 310. The enclosure associated with each of a plurality of storage devices is determined 320. The RAID controller performs a fault tolerance analysis on the storage devices based upon a distribution of the storage devices 330. The RAID controller selects a distribution order for the storage devices within a RAID system based on the fault tolerance analysis to provide maximum fault tolerance for the RAID 340. In performing the fault tolerance analysis, the RAID controller may consider different types and orders of failure affecting all storage devices in an enclosure. The RAID controller may also consider failures of the link to the storage devices.

The process illustrated with reference to FIGS. 1-3 may be tangibly embodied in a computer-readable medium or carrier, e.g. one or more of the fixed and/or removable data storage devices 288 illustrated in FIG. 2, or other data storage or data communications devices. The computer program 290 may be loaded into memory 236 of A RAID controller 222 to configure the RAID controller 222 for execution. The computer program 290 include instructions which, when read and executed by a processor, such as processors 234 of FIG. 2, causes the RAID controller to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. A method for providing RAID storage, comprising:
determining an enclosure associated with each of a plurality of storage devices;
performing a fault tolerance analysis on the storage devices; and
selecting a distribution order for the storage devices within a RAID system based on the fault tolerance analysis to provide maximum fault tolerance for the RAID system.

2. The method of claim 1, wherein the performing a fault tolerance analysis further comprises considering a failure affecting all storage devices in an enclosure.

3. The method of claim 1, wherein the performing a fault tolerance analysis further comprises considering cable failures to the storage devices.

4. The method of claim 1, wherein the selecting a distribution order for the storage devices within a RAID system further comprises obtaining a distribution that allows a RAID to be sustained even though an entire enclosure of storage devices fails.

5. A RAID controller, comprising:
a memory for storing data; and
a processor, coupled to the memory, the processor being configured for determining an enclosure associated with each of a plurality of storage devices, performing a fault tolerance analysis on the storage devices and selecting a distribution order for the storage devices within a RAID system based on the fault tolerance analysis to provide maximum fault tolerance for the RAID system.

6. The RAID controller of claim 1, wherein the processor is further configured to perform the fault tolerance analysis by considering a failure affecting all storage devices in an enclosure.

7. The RAID controller of claim 1, wherein the processor is further configured to perform the fault tolerance analysis by considering cable failures to the storage devices.

8. The RAID controller of claim 1, wherein the processor selects a distribution order that allows a RAID to be sustained even though an entire enclosure of storage devices fails.

9. A RAID storage system, comprising:
a plurality of storage devices disposed within storage device enclosures; and
a RAID controller, coupled to the plurality of storage devices, the RAID controller determining an enclosure associated with each of a plurality of storage devices, performing a fault tolerance analysis on the storage devices and selecting a distribution order for the storage devices within a RAID system based on the fault tolerance analysis to provide maximum fault tolerance for the RAID system.

10. The RAID storage system of claim 9, wherein the processor is further configured to perform the fault tolerance analysis by considering a failure affecting all storage devices in an enclosure.

11. The RAID storage system of claim 9, wherein the processor is further configured to perform the fault tolerance analysis by considering cable failures to the storage devices.

12. The RAID storage system of claim 9, wherein the processor selects a distribution order that allows a RAID to be sustained even though an entire enclosure of storage devices fails.

13. The RAID storage system of claim 9 further comprising a processor and a memory for storing program instructions for controlling the processor.

14. The RAID storage system of claim 9 further comprising a host coupled to the RAID controller, the host providing software access to the RAID controller.

15. The RAID storage system of claim 9, wherein the RAID controller stripes data across an array of storage devices so that the array appears as one logical storage device unit.

16. A program storage device readable by a computer, the program storage device tangibly embodying one or more programs of instructions executable by the computer to perform a method for optimizing storage device distribution within a RAID, the method comprising:
determining an enclosure associated with each of a plurality of storage devices;
performing a fault tolerance analysis on the storage devices; and
selecting a distribution order for the storage devices within a RAID system based on the fault tolerance analysis to provide maximum fault tolerance for the RAID system.

17. The program storage device of claim 1, wherein the performing a fault tolerance analysis further comprises considering a failure affecting all storage devices in an enclosure.

18. The program storage device of claim 1, wherein the performing a fault tolerance analysis further comprises considering cable failures to the storage devices.

19. The program storage device of claim 1, wherein the selecting a distribution order for the storage devices within a RAID system further comprises obtaining a distribution that allows a RAID to be sustained even though an entire enclosure of storage devices fails.

20. A RAID controller, comprising:
means for storing data; and
means, coupled to the means for storing data, for processing instruction to determine an enclosure associated with each of a plurality of storage devices, to perform a fault tolerance analysis on the storage devices and to select a distribution order for the storage devices within a RAID system based on the fault tolerance analysis to provide maximum fault tolerance for the RAID system.

21. A RAID storage system, comprising:
means for providing storage space, the means for providing storage space being enclosed within means for grouping the means for providing storage space; and
means, coupled to the means for providing storage space, for determining an enclosure associated with each of a plurality of storage devices, performing a fault tolerance analysis on the storage devices and selecting a distribution order for the storage devices within a RAID system based on the fault tolerance analysis to provide maximum fault tolerance for the RAID system.
